(19) United States
(12) Patent Application Publication
(10) Pub. No.: US 2009/0166940 A1
(43) Pub. Date: Jul. 2, 2009

(54) Spring plate for a vibration damper

(76) Inventor: Dieter Lutz, Schweinfurt (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/920,604

(22) PCT Filed: Jun. 16, 2006
(86) PCT No.: PCT/EP2006/005777

§ 371 Date: Nov. 16, 2007

(30) Foreign Application Priority Data
Jun. 22, 2005 (JP) 10 2005 028 761.1

(51) Int. Cl. F16F 1/12

(52) U.S. Cl. 267/170

(57) ABSTRACT

A spring plate for supporting a coil spring of a vibration damper includes a metal base body and a plurality of discrete insulating segments positioned on the base body. Each insulating segment has a contact surface which contacts an end of the coil spring, and an edge part which prevents the spring from migrating radially. Each insulating segment can be replaced independently of the other insulating segments.

### TECHNICAL AREA

The invention pertains to a spring plate for a vibration damper according to the introductory clause of Claim 1.

### PRIOR ART

A spring plate for a vibration damper is known from EP 1 443 238 A1, which represents the prior art. This spring plate has a plurality of contact surfaces for a vehicle suspension spring. There is a certain circumferential gap between the contact surfaces, so that free spaces are present, which, under certain conditions, accommodate any dimensional deviations which may be present in the suspension spring and thus can compensate for them. In addition, the division of the contact surface into parts minimizes the amount of noise which the suspension spring generates as a result of frictional movement against the contact surface.

Two different possibilities of realizing the contact surfaces are described. First, it is possible for the spring plate to have webs extending in the radial direction, on which the contact surfaces are formed. These webs also have outer edge parts, which are intended to prevent the vehicle suspension spring from migrating radially across the contact surface. Alternatively, a spring plate can be provided all the way around with a closed circumferential edge as shown in FIGS. 9 and 10, for example, and a plastic support with segmented contact surfaces can be used. The outer edge is formed by the metal support surface provided for the plastic support.

### DESCRIPTION OF THE INVENTION

The task of the present invention is to realize a spring plate with a plurality of contact surfaces for a vehicle suspension spring, where the spring plate is very light in weight but can still be subjected to heavy loads.

According to the invention, this task is accomplished in that at least some of the contact surfaces are designed as individual segments, each of which can be replaced independently of adjacent contact surfaces.

The great advantage is that, through the use of individual segments with a few basic forms, it is possible to accommodate a very wide spectrum of variations with respect to the shape of the final turn of the vehicle suspension spring. In addition, a large volume of material is eliminated—material which, according to the prior art, is necessary between the contact surfaces.

To obtain a spring plate with the lowest possible weight, the support body has radially oriented webs, on which the individual segments are arranged. The web-like design of the support body also makes it possible to use a much smaller steel sheet billet.

According to a subclaim, the radially oriented webs have retaining surfaces for the individual segments. The retaining surfaces are formed by web elements extending in the circumferential direction, which fit into grooves in the individual segments. This ensures that the individual segments are held in place in the radial direction.

In addition, the individual segments are supported in the circumferential direction at least on one side against the radially oriented webs of the support body.

So that the individual segments are captured especially during the installation phase, the support body is provided with through-openings for fastening elements on the individual segments.

The contact surfaces are designed as troughs, which guide the suspension spring radially in both directions.

In addition, one contact surface is designed with an end stop for the vehicle suspension spring.

So that the suspension spring can be guided even after its breaks, a spring capture surface is provided on each individual segment radially to the contact surface.

When the spring breaks, the webs of the support body also help to provide guidance, in that they are designed with support surfaces, at least some of which have essentially the same radial dimension as the spring capture surfaces of the individual segments.

To save weight, each of the support surfaces of the support body is provided with at least one through-opening.

To achieve maximum strength, at least some of the webs of the support body have a U-shaped cross section. In addition, at least one trough-like connecting segment can be present between two of the webs of the support body adjacent to each other in the circumferential direction.

### BRIEF DESCRIPTION OF THE DRAWINGS

The invention is explained in greater detail below on the basis of the following description of the figures:

FIG. 1 shows a perspective view of the support body of the inventive spring plate;

FIG. 2 shows a top view of the spring plate; and

FIG. 3 shows a cross section through the spring plate according to FIG. 2.

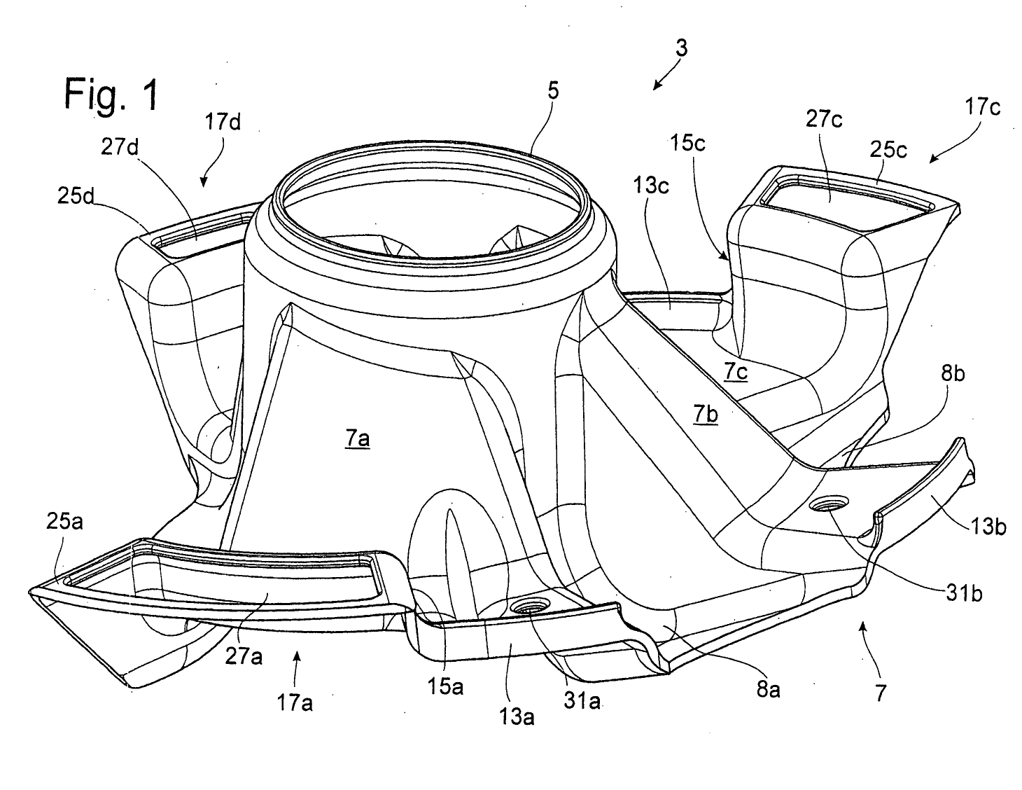

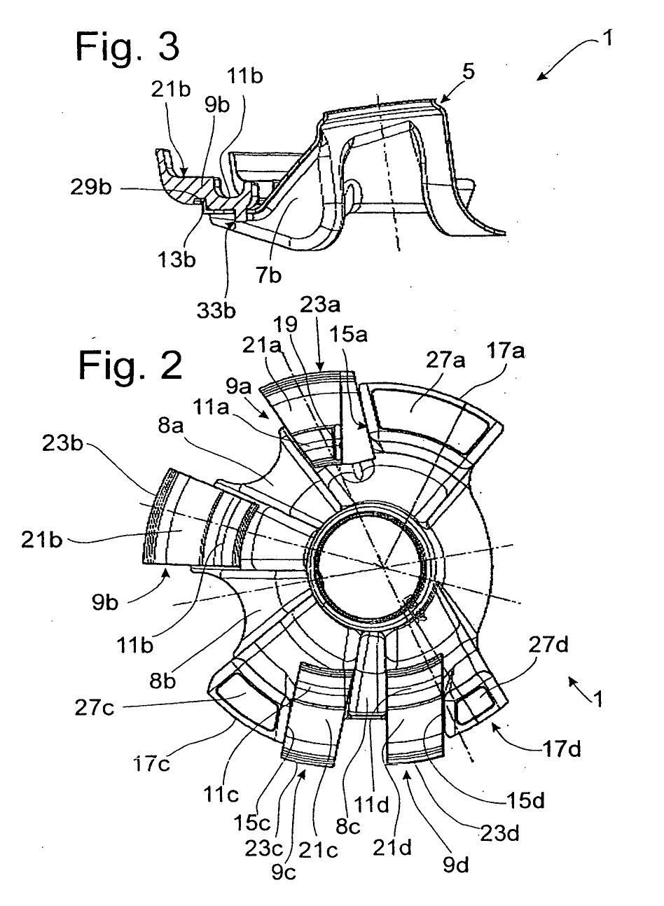

Consideration of FIGS. 1-3 together reveals a spring plate 1 with a metal support body 3 (FIG. 2), which is shaped from a sheet metal blank. The support body comprises a sleeve-like base body 5, which is attached to the cylinder of a vibration damper (not shown). Radial webs 7 are arranged around the circumference. At least some of these webs have a U-shaped cross section, opening downward. Between two circumferentially adjacent webs, e.g., 7a and 7b, there is a trough-like connecting element 8a-8. Overall, the connecting elements and the webs form a wave-like cross-sectional profile.

Individual segments 9a, 9b, 9c, 9d, which are independent of each other and replaceable, are arranged on the webs 7 of the support body and are provided with contact surfaces 11a-11d. For this purpose, the radially oriented webs have attachment surfaces in the form of web elements 13a-13d, extending in the circumferential direction. The individual segments are also supported in the circumferential direction on at least one side by lateral surfaces 15a-15c of the radial webs 7a-7d, which terminate at angled edge parts 17a-17d.

The contact surfaces 11a-11d are designed as troughs. In addition, a contact surface 11a has an end stop 19 for the vehicle suspension spring. In an offset parallel plane, spring capture surfaces 21a-21d are provided on the individual segments 9a-9d radially to the contact surfaces 11a-11d; these capture surfaces are bounded radially on the outside by circumferential edge parts 23a-23d, which prevent the suspension spring from moving away in the event of breakage.

On the edge parts 17a-17d, support surfaces 25a-25d are formed, at least some of which are of the same dimension as the spring capture surfaces 21a-21d of the individual segments 9a-9d and lie in the same horizontal plane. The support surfaces 25a-25d can be provided with through-openings 27a-27d.

When the spring plate 1 is assembled, the individual segments 9a-9d are placed on the webs 7a-7d of the support body 3 as a function of the geometry of the final turn of the vehicle suspension spring. The web elements 13a-13d fit into grooves, e.g., 29b in FIG. 3, in the individual segments and thus provide support in the radial direction. In addition, the webs 7a-7d also have through-openings 31a, 31b for pin-like fastening elements such as 33b (FIG. 3) at the end of the segments 9a-9d, so that the components cannot come apart.

Overall, a very light-weight but very strong spring plate is obtained, the individual segments of which can accept vehicle suspension springs of various sizes.

1.-13. (canceled)

14. A spring plate for supporting a coil spring of a vibration damper, the spring plate comprising:
a metal base body; and
a plurality of discrete insulating segments positioned on said base body, each insulating segment having a contact surface which contacts an end of the coil spring, and an edge part which prevents the spring from migrating radially.

15. The spring plate of claim 14 wherein the support body comprises radial webs on which respective insulating segments are arranged.

16. The spring plate of claim 15 wherein the radial webs have respective circumferentially extending web elements which retain the insulating segments radially.

17. The spring plate of claim 16 wherein each insulating segment has a groove, each said circumferentially extending web element fitting into a respective said groove.

18. The spring plate of claim 15 wherein the radial webs each have at least one radially extending retaining surface which supports a respective said insulating segment circumferentially.

19. The spring plate of claim 14 wherein the support body has apertures for securing the insulating segments to the support body.

20. The spring plate of claim 14 wherein the contact surfaces have the form of troughs.

21. The spring plate of claim 20 wherein one of said troughs is formed with an end stop for limiting circumferential migration of said spring.

22. The spring plate of claim 14 wherein each said insulating segment comprises a spring capture surface situated radially outward of a respective said contact surface.

23. The spring plate of claim 22 wherein the metal base body comprises support surfaces located circumferentially adjacent to respective said insulating segments, at least some of said support surfaces having a radial dimension which is the substantially the same as the radial dimension of the adjacent said spring capture surface.

24. The spring plate of claim 22 wherein each said support surface as at least one aperture.

25. The spring plate of claim 15 wherein at least some of the radial webs have a U-shaped cross section.

26. The spring plate of claim 15 further comprising at least one trough-like connecting segment between two of said radial webs which are circumferentially adjacent to each other.
